(19) United States
(12) Patent Application Publication
(10) Pub. No.: US 2022/0199301 A1
(43) Pub. Date: Jun. 23, 2022

(54) R-T-B BASED PERMANENT MAGNET

(71) Applicant: TDK Corporation, Tokyo (JP)

(72) Inventors: Kenichi SUZUKI, Tokyo (JP); Yoshinori FUJIKAWA, Tokyo (JP)

(73) Assignee: TDK Corporation, Tokyo (JP)

(21) Appl. No.: 17/554,208

(22) Filed: Dec. 17, 2021

(30) Foreign Application Priority Data
Dec. 22, 2020 (JP) 2020-212648
Oct. 14, 2021 (JP) 2021-169034

(51) Int. Cl. H01F 1/057; C22C 38/00

(52) U.S. Cl. CPC H01F 1/0577; C22C 38/005

(57) ABSTRACT

To provide an R-T-B based permanent magnet in which the residual magnet flux density and the coercivity are improved. Provided is an R-T-B based permanent magnet including a rare-earth element R, and transition metal elements T and B. The R-T-B based permanent magnet includes at least Nd as R, the R-T-B based permanent magnet includes at least Fe among Fe and Co as T, the R-T-B based permanent magnet includes a plurality of main phase grains containing a crystal of R₂T₁₄B, and a two-grain boundary located between two main phase grains adjacent in an axis-of-easy-magnetization direction, the thickness of the two-grain boundary is 3 nm or less, and the two-grain boundary is crystalline, and is non-oriented.

### TECHNICAL FIELD

The present disclosure relates to an R-T-B based permanent magnet.

### BACKGROUND

The R-T-B based permanent magnet includes a rare-earth element R (such as Nd), a transition metal element T (such as Fe), and boron (B). The R-T-B based permanent magnet is excellent in magnetic characteristics, and has been widely used. As the R-T-B based permanent magnet, there are a sintered magnet manufactured by a powder metallurgy method, and a hot deformed magnet manufactured by a hot plastic deformation method (refer to, for example Patent Literatures 1 to 3).

### CITATION LIST

### Patent Literature

Patent Literature 1: Japanese Unexamined Patent Publication No. 2016-96203

Patent Literature 2: Japanese Unexamined Patent Publication No. 2018-107328

Patent Literature 3: Japanese Unexamined Patent Publication No. 2016-29679

As an index indicating magnetic characteristics of the R-T-B based permanent magnet, typically, residual magnetic flux density (Br) and coercivity (HcJ) can be used.

Here, an alloy thin strip that is a raw material of the hot deformed magnet is obtained by a rapid solidification method. In the rapid solidification method, a molten metal of the R-T-B based alloy is rapidly cooled down on a surface of a cooled roll. As a result, the molten metal solidifies, and the alloy thin strip is formed. The alloy thin strip obtained by the rapid solidification method contains microcrystals of an alloy (and an amorphous alloy). Accordingly, crystal grains (main phase grains) which constitute the hot deformed magnet are finer in comparison to the sintered magnet. As shown in Kronmuller's formula, there is known that as a crystal grain size of the R-T-B based permanent magnet is finer, the coercivity further increases. Accordingly, the hot deformed magnet will have higher coercivity in comparison to the sintered magnet. However, the coercivity of the hot deformed magnet in the related art is the same as the coercivity of the sintered magnet having the same composition, and the high coercivity that is expected from the fine crystal grain size is not obtained.

In addition, the R-T-B based permanent magnet (for example, the hot deformed magnet) in the related art also has room for improvement in the residual magnet flux density.

### SUMMARY

An aspect of the present invention has been made in consideration such circumstances, and an object thereof is to provide an R-T-B based permanent magnet in which the residual magnet flux density and the coercivity are improved.

According to an aspect of the present invention, there is provided an R-T-B based permanent magnet including a rare-earth element R, and transition metal elements T and B,

wherein the magnet includes at least Nd as R,

the magnet includes at least Fe among Fe and Co as T,

the magnet includes a plurality of main phase grains containing a crystal of R₂T₁₄B, and a two-grain boundary located between two main phase grains adjacent in an axis-of-easy-magnetization direction,

the thickness of the two-grain boundary is 3 nm or less, and

the two-grain boundary is crystalline, and is non-oriented.

The content of R in the R-T-B based permanent magnet may be from 28% by mass to 33% by mass, and the content of B in the R-T-B based permanent magnet may be from 0.8% by mass to 1.1% by mass.

The R-T-B based permanent magnet may further include Ga, and the two-grain boundary may be a phase containing R₆T₁₃Ga.

The R-T-B based permanent magnet may be a hot deformed magnet.

According to the aspect of the invention, there is provided an R-T-B based permanent magnet in which the residual magnet flux density and the coercivity are improved.

### BRIEF DESCRIPTION OF THE DRAWINGS

FIG. 1A is a perspective view of an R-T-B based permanent magnet according to an embodiment of the invention.

FIG. 1B is a cross-sectional view (an arrow view in a direction of line b-b) of the R-T-B based permanent magnet illustrated in FIG. 1A.

FIG. 2 is a schematic view of a cross-section (region II) of the R-T-B based permanent magnet illustrated in FIG. 1B.

FIG. 3A is an HAADF-STEM image obtained by observing a cross-section of the R-T-B based permanent magnet according to the embodiment of the invention with STEM.

FIG. 3B is an image around a bright spot obtained by performing FFT on a region that is a part of the two-grain boundary in the HAADF-STEM image shown in FIG. 3A.

FIG. 3C is an image around a bright spot obtained by performing FFT on a region that is a part of the two-grain boundary in the HAADF-STEM image shown in FIG. 3A.

FIG. 4 is a flowchart illustrating a method of manufacturing the permanent magnet according to this embodiment.

FIG. 5 is a schematic perspective view illustrating an extrusion mold that is used in a hot deforming step.

FIG. 6 is a view illustrating an inlet portion, a plastic deforming portion, and an outlet portion of the extrusion mold illustrated in FIG. 5.

FIG. 7 is a view illustrating an inlet portion, a plastic deforming portion, and an outlet portion of the extrusion mold illustrated in FIG. 5.

### DETAILED DESCRIPTION

Hereinafter, a preferred embodiment of the invention will be described with reference to the accompanying drawings. In the drawings, an equivalent reference numeral will be given to an equivalent constituent element. The present invention is not limited to the following embodiment. In the following description, “permanent magnet” represents an R-T-B based permanent magnet. In the following description, a unit of a concentration of each element is atomic %.

(Permanent Magnet)

A permanent magnet according to this embodiment includes a rare-earth element (R), a transition metal element (T), and boron (B). The permanent magnet according to this embodiment is a hot deformed magnet. The permanent magnet according to the present invention may be a sintered magnet.

The permanent magnet includes at least neodymium (Nd) as the rare-earth element R. The permanent magnet may further include another rare-earth element R in addition to Nd. The other rare-earth element R may be at least one kind selected from the group consisting of scandium (Sc), yttrium (Y), lanthanum (La), cerium (Ce), praseodymium (Pr), samarium (Sin), europium (Eu), gadolinium (Gd), terbium (Tb), dysprosium (Dy), holmium (Ho), erbium (Er), thulium (Tin), ytterbium (Yb), and lutetium (Lu).

The permanent magnet includes at least iron (Fe) as the transition metal element T. The permanent magnet may include only Fe as the transition metal element T. The permanent magnet may include both Fe and cobalt (Co) as the transition metal element T.

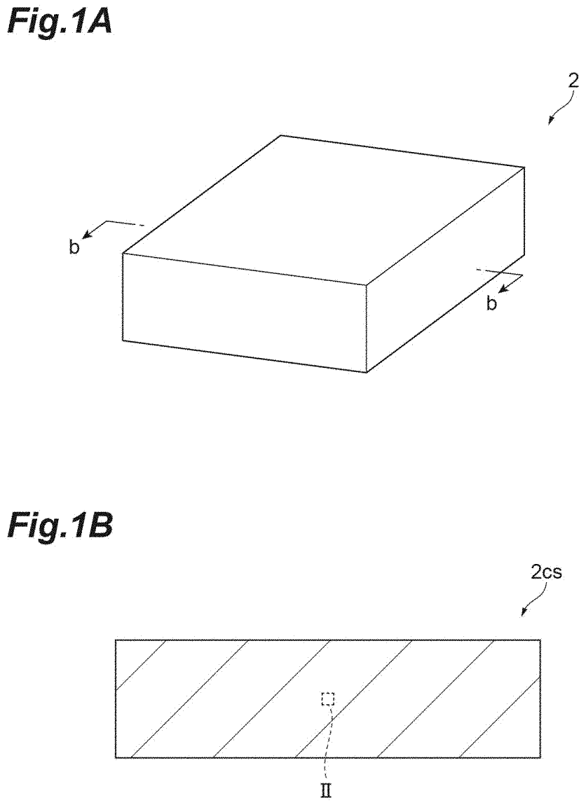

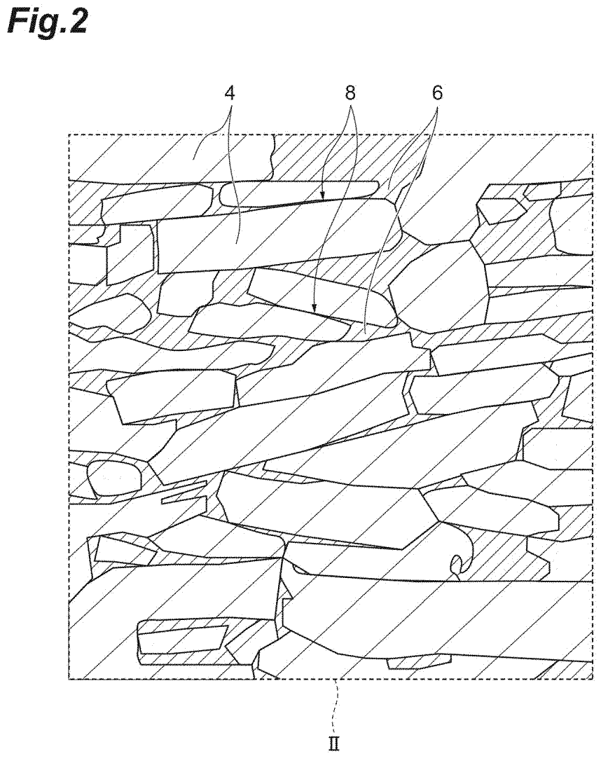

FIG. 1A is a schematic perspective view of a rectangular parallelepiped permanent magnet 2 according to this embodiment, FIG. 1B is a schematic view of a cross-section 2cs of the permanent magnet 2, and FIG. 2 is an enlarged view of a part (region II) of the cross-section 2cs of the permanent magnet 2. The cross-section 2cs of the permanent magnet 2 may be approximately parallel to an axis-of-easy-magnetization direction C of the permanent magnet 2. The axis-of-easy-magnetization direction C may be specified on the basis of measurement of the magnetic flux distribution of the permanent magnet 2. The axis-of-easy-magnetization direction C may be specified on the basis of measurement of the magnetic flux distribution of an analysis sample separated from the permanent magnet 2.

The permanent magnet 2 according to this embodiment has a rectangular parallelepiped shape. However, the shape of the permanent magnet 2 is not limited to the rectangular parallelepiped shape. For example, the shape of the permanent magnet 2 may be cube, a polygonal prism, an arc segment, an annular sector, a sphere, a disk, a cylinder, a tube, or a ring.

As illustrated in FIG. 2, the permanent magnet 2 includes a plurality (enormous number) of main phase grains 4. The main phase grains 4 include at least Nd, T, and B. The main phase grains 4 may be referred to as a crystal grain or a primary grain. The main phase grain 4 contains a crystal (a single crystal or a polycrystal) of R₂T₁₄B. The main phase grain 4 may be composed of only the crystal of R₂T₁₄B. The crystal of R₂T₁₄B may be tetragonal. That is, crystal axes of the crystal of R₂T₁₄B are an a-axis, a b-axis, and a c-axis, the a-axis, the b-axis, and the c-axis are orthogonal to each other, a lattice constant of R₂T₁₄B in an a-axis direction may be equal to a lattice constant of R₂T₁₄B in a b-axis direction, and a lattice constant of R₂T₁₄B in a c-axis direction may be different from the lattice constants in the a-axis direction and the b-axis direction. The c-axis direction of R₂T₁₄B may be approximately parallel to an axis-of-easy-magnetization direction C of the permanent magnet 2.

The main phase grains 4 may include another element in addition to Nd, T, and B. For example, R₂T₁₄B that constitutes the main phase grain 4 may be expressed by (Nd₁₋ₓPrₓ)₂(Fe_{1-y}Co_{y})₁₄B. x may be 0 or more and less than 1. y may be 0 or more and less than 1. The main phase grain 4 may include a heavy rare-earth element such as Tb and Dy as R in addition to a light rare-earth element. Apart of B in R₂T₁₄B may be substituted with another element such as gallium (Ga) and carbon (C). A composition in the main phase grain 4 may be uniform. The composition in the main phase grain 4 may be non-uniform. For example, a concentration distribution of each of R, T, and B in the main phase grain 4 may have a gradient.

The main phase grain 4 may be composed of a surface layer part, and a center part covered with the surface layer part. The surface layer part may be referred to as a shell, and the center part may be referred to as a core. The surface layer part of the main phase grain 4 may include at least one kind of heavy rare-earth element among Tb and Dy. The surface layer part of all of the entirety of main phase grains 4 may include at least one kind of heavy rare-earth element among Tb and Dy. The surface layer part of some main phase grains 4 among all of the main phase grains 4 may include at least one kind of heavy rare-earth element among Tb and Dy. When the surface layer part includes the heavy rare-earth element, an anisotropic magnetic field is likely to increase locally near a grain boundary, and a magnetization reversal nucleus is less likely to occur near a grain boundary. As a result, the coercivity of the permanent magnet 2 at a high temperature (for example, 100° C. to 200° C.) increases. From the viewpoint that the residual magnetic flux density and the coercivity of the permanent magnet 2 are likely to be compatible, a total concentration of the heavy rare-earth elements in the surface layer part may be higher than a total concentration of the heavy rare-earth elements in the center part.

Although a major axis and a minor axis of the main phase grain 4 are not particularly limited, for example, the major axis may be 100 to 1000 nm, and the minor axis may be 20 to 200 nm. Although not particularly limited, for example, a total volume ratio of the main phase grains 4 in the permanent magnet 2 may be 80% by volume or more, and may be less than 100% by volume. The major axis and the minor axis of the main phase grains 4 are lengths of a long side and a short side of a quadrangle which is circumscribed around the main phase grain 4 and of which an area becomes minimum in an HAADF-STEM image obtained by observing a cross-section of the permanent magnet 2 with a STEM (scanning transmission electron microscope).

The permanent magnet 2 includes a plurality of grain boundary multiple junctions 6. Each of the grain boundary multiple junctions 6 is a grain boundary phase surrounded by at least three main phase grains 4. In addition, the permanent magnet 2 includes a plurality of two-grain boundaries 8. Each of the two-grain boundaries 8 is a grain boundary phase located between two main phase grains 4 adjacent in an axis-of-easy-magnetization direction. The grain boundary may include at least Nd, and the content of Nd in the grain boundary may be more than the content of Nd in the main phase grain. That is, the grain boundary may include an Nd-rich phase. The grain boundary may include at least one kind among Fe and B in addition to Nd.

The thickness of the two-grain boundary 8 is 3 nm or less. From the viewpoint that the coercivity and the residual magnetic flux density become higher, and squareness is improved, the thickness of the two-grain boundary 8 may be 0.8 nm or more. The thickness of the two-grain boundary 8 is an average value of measured values of the thickness at arbitrary 10 or more sites in the HAADF-STEM image obtained by observing a cross-section of the permanent magnet 2 with a STEM (scanning transmission electron microscope). The magnification of the HAADF-STEM image may be set to conditions in which a lattice image can be clearly observed. The average value of the measurement values of the thickness at arbitrary 10 or more sites in the HAADF-STEM image is an average value of values obtained as follows. Specifically, adjacent two main phase grains are set as one set, 10 or more sets are arbitrarily selected in one sheet of HAADF-STEM image, and the thickness of a grain boundary phase located between the two main phase grains in each set is measured as the values.

The two-grain boundary 8 is crystalline. The crystallinity of the two-grain boundary 8 can be confirmed by the following method. Specifically, the HAADF-STEM image is obtained by observing a cross-section of the permanent magnet 2 with a STEM (scanning transmission electron microscope). In the obtained HAADF-STEM image, arbitrary five or more regions (2×2 nm) which are parts of the two-grain boundary 8 is subjected to FFT (two-dimensional Fourier transform) to obtain an image around a bright spot (direct spot). It is determined that the two-grain boundary 8 is crystalline in a case where a bright spot other than the central bright spot (direct spot) is observed in at least one image among images obtained from the five or more regions.

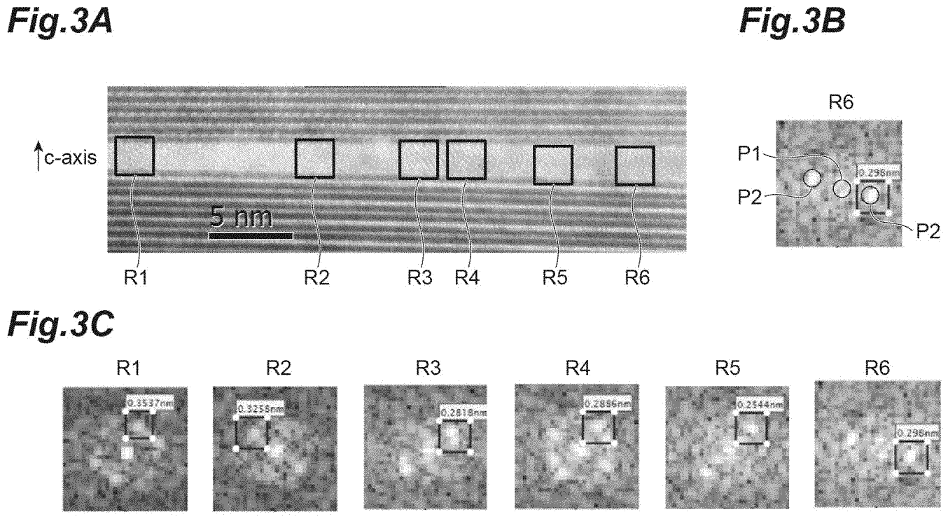

FIG. 3A is the HAADF-STEM image obtained by observing the cross-section of the permanent magnet 2 with a STEM. FIG. 3B and FIG. 3C are images around a bright spot obtained by subjecting a region (size: 2×2 nm) that are parts of a two-grain boundary in the HAADF-STEM image in FIG. 3A to FFT. As shown in FIG. 3B, in a region R6, two bright spots P2 other than a central bright spot P1 can be observed. As shown in FIG. 3C, in regions R1 to R5, a bright spot other than a central bright spot is also observed in a similar manner.

The two-grain boundary 8 is non-oriented and in other words orientation is random. The fact that the two-grain boundary 8 is non-oriented can be confirmed by the following method. Specifically, a cross-section of the permanent magnet 2 is observed with the STEM to obtain an HAADF-STEM image. In the obtained HAADF-STEM image, arbitrary five or more regions (2×2 nm) which are parts of the two-grain boundary 8 is subjected to FFT (two-dimensional Fourier transform) to obtain an image around a bright spot (direct spot). A plurality of the obtained images are compared, and in a case where bright spots other than a central bright spot (direct spot) do not overlap each other, it is determined that the two-grain boundary 8 is non-oriented.

The two-grain boundary 8 may be a phase containing R₆T₁₃Ga in a case where the permanent magnet 2 contains Ga. In a case where the two-grain boundary 8 is a phase containing R₆T₁₃Ga, Nd and Fe in a surface of the main phase grain 4 shows anisotropy that contributes to an increase in the coercivity. According to this, the coercivity of the permanent magnet 2 is further improved.

Presence or absence of R₆T₁₃Ga in the two-grain boundary 8 may be determined through analysis of a composition and a lattice constant of the two-grain boundary 8. The composition of the two-grain boundary 8 may be analyzed by energy dispersive fluorescent X-ray spectroscopy (EDX). The lattice constant of the two-grain boundary 8 can be confirmed by the following method. Specifically, a cross-section of the permanent magnet 2 is observed with a STEM to obtain a HAADF-STEM image. In the obtained HAADF-STEM image, arbitrary five or more regions (2×2 nm) which is a part of the two-grain boundary 8 are subjected to two-dimensional Fourier transform to calculate periodicity (a surface interval and a lattice constant).

A composition of each of the main phase grain 4 and the grain boundary phase may be specified by analysis of each of the main phase grain 4 and the grain boundary phase which are exposed to a cross-section 2cs of the permanent magnet 2. The main phase grain 4 and the grain boundary phase which are exposed to the cross-section 2cs of the permanent magnet 2 are easily identified on the basis of signal intensity of a reflected electron image captured by an electron probe microanalyzer (EPMA). The composition of each of the main phase grain 4 and the grain boundary phase may be analyzed by the electron probe microanalyzer (EPMA) or energy dispersive X-ray spectroscopy (EDS).

An entire composition of the permanent magnet 2 will be described below. However, the composition of the permanent magnet 2 is not limited to the following composition. The content of each element in the permanent magnet 2 may deviate from the following ranges.

A total content of rare-earth elements R in the permanent magnet 2 may be from 25.00% by mass to 35.00% by mass, or from 28.00% by mass to 33.00% by mass. When the content of R is within the above-described range, the residual magnetic flux density and the coercivity of the permanent magnet 2 are likely to increase. In a case where the content of R is excessively small, R₂T₁₄B that constitutes the main phase grain 4 is less likely to be formed, and an a-Fe phase having soft magnetism is likely to be formed. As a result, the coercivity is likely to decrease. On the other hand, in a case where the content of R is excessively large, a volume ratio of the main phase grain 4 decreases, and the residual magnetic flux density is likely to decrease. From the viewpoint that the residual magnetic flux density and the coercivity are likely to increase, a total ratio of Nd and Pr to the entirety of rare-earth element R may be from 80 to 100 atomic %, or from 95 to 100 atomic %.

A total content of Tb and Dy in the permanent magnet 2 may be from 0.20% by mass to 5.00% by mass. When the permanent magnet 2 includes at least one kind heavy rare-earth element among Tb and Dy, magnetic characteristics (particularly, the coercivity at a high temperature) are likely to increase. However, the permanent magnet 2 may not include Tb and Dy.

The content of B in the permanent magnet 2 may be from 0.70% by mass to 1.10% by mass, or from 0.80% by mass to 1.10% by mass. In a case where the content of B is 0.70% by mass or more, the residual magnetic flux density is likely to increase. In a case where the content of B is 1.10% by mass or less, the coercivity of the permanent magnet 2 is likely to increase. In a case where the content of B is within the above-described range, a squareness ratio (Hk/HcJ) of the permanent magnet 2 is likely to approach 1.0. Elk is intensity of a demagnetizing field corresponding to 90% of the residual magnetic flux density.

The permanent magnet 2 may include gallium (Ga). The content of Ga may be from 0.03% by mass to 1.00% by mass, or from 0.20% by mass to 0.80% by mass. In a case where the content of Ga is within the above-described range, generation of sub-phase (for example, a phase including R, T, and Ga) is appropriately suppressed, and the residual magnetic flux density and the coercivity of the permanent magnet 2 are likely to increase. However, the permanent magnet 2 may not include Ga.

The permanent magnet 2 may include aluminum (Al). The content of Al in the permanent magnet 2 may be from 0.01% by mass to 0.2% by mass, or from 0.04% by mass to 0.07% by mass. When the content of Al is within the above-described range, the coercivity and corrosion resistance of the permanent magnet are likely to be improved. However, the permanent magnet 2 may not include Al.

The permanent magnet 2 may include copper (Cu). The content of Cu in the permanent magnet 2 may be from 0.01% by mass to 1.50% by mass, or from 0.04% by mass to 0.50% by mass. When the content of Cu is within the above-described range, the coercivity, the corrosion resistance, and temperature characteristics of the permanent magnet 2 are likely to be improved. However, the permanent magnet 2 may not include Cu.

The permanent magnet 2 may include cobalt (Co). The content of Co in the permanent magnet may be from 0.30% by mass to 6.00% by mass, or from 0.30% by mass to 4.00% by mass. When the permanent magnet 2 include Co, a Curie temperature of the permanent magnet 2 is likely to be improved. In addition, when the permanent magnet 2 include Co, the corrosion resistance of the permanent magnet 2 is likely to be improved. However, the permanent magnet 2 may not include Co.

The balance excluding the above-described element from the permanent magnet 2 may be only Fe, or Fe and other elements. In order for the permanent magnet 2 to have sufficient magnetic characteristics, in the balance, a total content of elements other than Fe may be 5% by mass or less with respect to the total mass of the permanent magnet 2.

The permanent magnet 2 may include at least one kind selected from the group consisting of silicon (Si), titanium (Ti), manganese (Mn), zirconium (Zr), vanadium (V), chromium (Cr), nickel (Ni), niobium (Nb), molybdenum (Mo), hafnium (Hf), tantalum (Ta), tungsten (W), bismuth (Bi), tin (Sn), calcium (Ca), carbon (C), nitrogen (N), oxygen (O), chlorine (CO, sulfur (S), and fluorine (F) as the other elements (for example, unavoidable impurities). The total content of the other elements in the permanent magnet 2 may be from 0.001% by mass to 0.50% by mass.

The composition of the entirety of the permanent magnet 2 may be analyzed, for example, by a fluorescent X-ray (XRF) analysis method, a high-frequency inductively coupled plasma (ICP) emission analysis method, an inert gas melting—non dispersive infrared absorption (NDIR) method, a combustion in oxygen stream—infrared absorption method, an inert gas melting—heat conductivity method, or the like.

The permanent magnet 2 may be applied to a motor, a generator, an actuator, or the like. For example, the permanent magnet 2 is used in various fields such as a hybrid vehicle, an electric vehicle, a hard disk drive, a magnetic resonance imaging apparatus (MRI), a smartphone, a digital camera, a flat-screen TV, a scanner, an air conditioner, a heat pump, a refrigerator, a vacuum cleaner, a washing and drying machine, an elevator, and a wind power generator.

[Operation and Effect]

In the permanent magnet, propagation of magnetization reversal between a plurality of main phase grains (that is, straddling of a magnetic wall over a grain boundary) occurs. With regard to propagation of magnetization reversal, since a two-grain boundary located between adjacent two main phase grains exists, the main phase grains are magnetically separated. According to this, it is considered that propagation of magnetization reversal can be suppressed as the two-grain boundary is thicker. However, in a case where the two-grain boundary is thick, the residual magnetic flux density tends to decrease. A reduction in the residual magnetic flux density due to the thick two-grain boundary becomes large, particularly, in a case where the permanent magnet is a hot deformed magnet. In the hot deformed magnet, since the major axis and the minor axis of the main phase grains are smaller in comparison to a sintered magnet, a specific surface area of the main phase grains is large. As a result, an influence of the thickness of the two-grain boundary on the residual magnetic flux density becomes large.

However, in the permanent magnet 2, since the two-grain boundary 8 is crystalline, and the two-grain boundary 8 is non-oriented, propagation of magnetization reversal that occurs between the main phase grains can be suppressed while the thickness of the two-grain boundary 8 is 3 nm or less. According to this, in the permanent magnet 2, the residual magnetic flux density and the coercivity are improved.

(Method of Manufacturing Permanent Magnet)

### First Embodiment

In this embodiment, as a method of manufacturing the permanent magnet, a method of manufacturing a hot deformed magnet will be described.

The method of manufacturing a hot deformed magnet according to this embodiment is a method of manufacturing a hot deformed magnet by using an extrusion mold that has a starting end surface and a termination end surface which face each other, and is provided with a plastic deforming portion including a starting end portion and a termination end portion, and an outlet portion including a starting end portion and a termination end portion. The portions are sequentially connected toward the starting end surface and the termination end surface. The method of manufacturing a hot deformed magnet according to this embodiment includes a hot deforming step of hot-extruding a green compact obtained by pressing a magnetic powder from the starting end surface of the extrusion mold to the termination end surface through the plastic deforming portion and the outlet portion. In the plastic deforming portion, an area of an end surface in a termination end portion is smaller than an area of an end surface in a starting end portion. In the outlet portion, an area of an end surface in a termination end portion is approximately the same as an area of an end surface in a starting end portion. A difference (T₁−T₂) between a temperature T₁ of the green compact in the starting end portion of the outlet portion and a temperature T₂ of the green compact in the starting end portion is 30° C. or higher.

The method of manufacturing the hot deformed magnet according to this embodiment has the above-described configuration, and an unloading rate exceeds 0. As a result, the two-grain boundary 8 included in the permanent magnet 2 that is obtained becomes non-oriented.

A starting raw material is weighed to match a composition of a desired permanent magnet 2. For example, the starting raw materials may be a metal, an alloy, or an oxide.

For example, the raw material alloy may be produced from the starting raw material by rapid solidification method. In order to suppress oxidation of the raw material alloy, the rapid solidification method may be performed in an argon gas atmosphere (or in a nitrogen gas atmosphere).

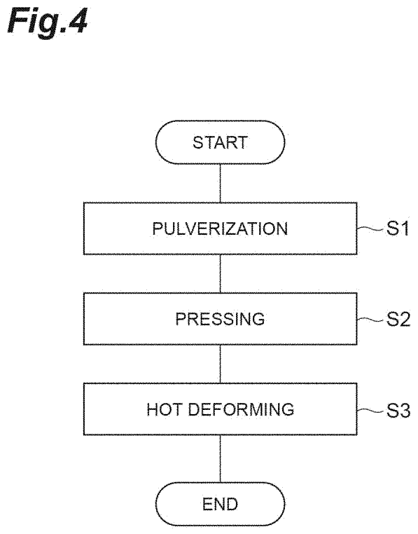

The raw material alloy obtained as described above is pulverized into a magnetic powder (step S1 in a flowchart in FIG. 4). For example, pulverization can be performed by a cutter mill or a propeller mill, for example, in an argon gas atmosphere (or in a nitrogen gas atmosphere). A particle size of the magnetic powder obtained through pulverization is, for example, approximately 100 to 300 μm. The magnetic powder is not finely pulverized up to a dimension level (approximately 40 nm) of a signal crystal of the permanent magnet 2, and has a polycrystal structure composed of a plurality of single crystals.

The magnetic powder obtained in step S1 is pressed by a compression molding machine, thereby obtaining a green compact (step S2 in the flowchart in FIG. 4). Pressing is performed in an argon gas atmosphere (or in a nitrogen gas atmosphere) at a high temperature of 800° C. or lower (for example, 750° C.) under a press pressure of 100 MPa or less for several tens of seconds. Through pressing, the magnetic powder grows into a plate shape, and a dense green compact is obtained. However, in a state of the green compact, magnetic grains which grow into a plate shape are randomly oriented, and thus axis-of-easy-magnetization directions are not aligned.

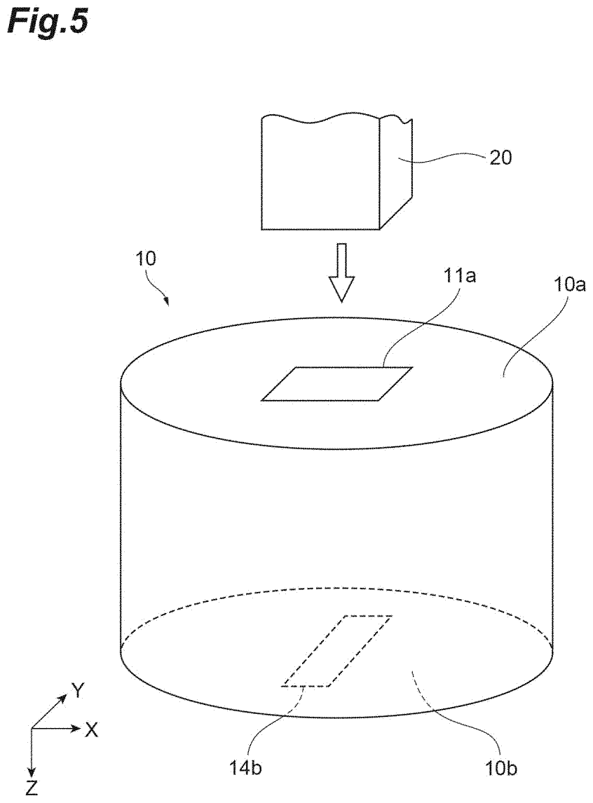

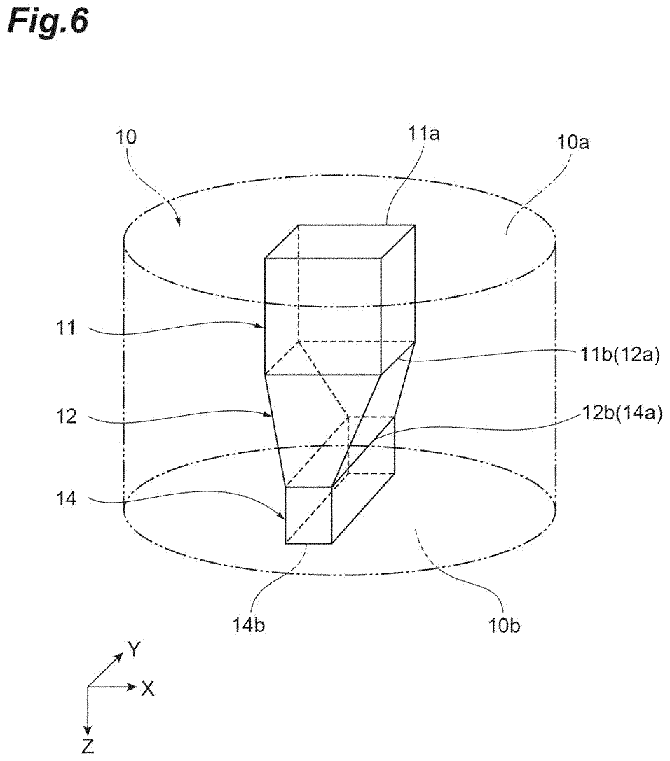

The green compact obtained in step S2 is hot deformed by a forward extrusion method, thereby obtaining a hot deformed magnet (step S3 in the flowchart in FIG. 4). Hot deforming is performed in an argon gas atmosphere (or in a nitrogen gas atmosphere, in the air) at a high temperature of 800° C. or lower (as an example, 750° C.) under a press pressure of 100 MPa or lower for several tens of seconds. In the hot deforming according to this embodiment, an extrusion mold illustrated in FIGS. 5 and 6 is used.

An extrusion mold 10 has a starting end surface 10a and a termination end surface 10b facing each other. In this embodiment, the extrusion mold 10 has a cylindrical external shape, and any of the starting end surface 10a and the termination end surface 10b has a circular shape. In this embodiment, the starting end surface 10a and the termination end surface 10b are parallel to each other. A material that constitutes the extrusion mold 10 is not particularly limited as long as the material has excellent mechanical strength at a high temperature. Examples of the material include a molybdenum alloy and a nickel alloy.

The extrusion mold 10 includes an inlet portion 11, a plastic deforming portion 12, and an outlet portion 14. The inlet portion 11, the plastic deforming portion 12, and the outlet portion 14 are sequentially connected from the starting end surface 10a toward the termination end surface 10b.

As illustrated in FIG. 5, in the extrusion mold 10, the above-described green compact disposed on the starting end surface 10a is forwardly extruded in a Z-direction toward the termination end surface 10b by using a punch 20 having a cross-sectional shape having the same dimension as (or slightly shorter than) an end surface shape of a starting end portion 11a of the inlet portion 11. According to tis, a strip-shaped hot deformed magnet having the same cross-sectional shape as an end surface shape of a termination end portion 14b of the outlet portion 14 is obtained. The strip-shaped hot deformed magnet is appropriately cut in a desired width.

The inlet portion 11 includes the starting end portion 11a in the starting end surface 10a and a termination end portion 11b. In the inlet portion 11, an area of an end surface in the termination end portion 11b is approximately the same as an area of an end surface in the starting end portion 11a. The starting end portion 11a and the termination end portion 11b have an end surface shape that extends in one direction when viewed from a facing direction of the starting end surface 10a and the termination end surface 10b. An end surface shape of the starting end portion 11a and the termination end portion 11b in this embodiment is a rectangular shape. A cross-sectional area in a cross-section orthogonal to the facing direction of the starting end surface 10a and the termination end surface 10b of the inlet portion 11 may be approximately constant from the starting end portion 11a toward the termination end portion 11b.

Hereinafter, for convenience of explanation, the facing direction of the starting end surface 10a and the termination end surface 10b is set as a Z-direction, a direction in which the end surface shape of the starting end portion 11a and the termination end portion 11b extends is set as an X-direction, and a direction orthogonal to the Z-direction and the X-direction is set as a Y-direction.

The plastic deforming portion 12 includes a starting end portion 12a connected to the termination end portion 11b, and a termination end portion 12b. In the plastic deforming portion 12, an area of an end surface in the termination end portion 12b is smaller than an area of an end surface in the starting end portion 12a. The starting end portion 12a and the termination end portion 12b of the plastic deforming portion 12 have end surface shapes extending in one direction when viewed from the facing direction of the starting end surface 10a and the termination end surface 10b. The end surface shapes of the starting end portion 12a and the termination end portion 12b are rectangular shapes. The end surface shape of the starting end portion 12a extends in the X-direction (that is, a long side conforms to an X-axis). In contrast, the end surface shape of the termination end portion 12b extends in the Y-direction (that is, a long side conforms to a Y-axis). When viewed from the facing direction of the starting end surface 10a and the termination end surface 10b, the X-direction (first direction) in which the end surface shape of the starting end portion 12a extends and the Y-direction (second direction) in which the end surface shape of the termination end portion 12b extends intersect each other, and more specifically, the X-direction and the Y-direction are orthogonal to each other. In the plastic deforming portion 12, the major axis and the minor axis can be expressed as being replaced with each other between the rectangular end surface of the starting end portion 12a and the rectangular end surface of the termination end portion 12b. The end surface of the starting end portion 12a and the end surface of the termination end portion 12b have a twisted positional relationship.

A contour of the plastic deforming portion 12 may be constituted by a straight line as illustrated in FIG. 6, or may be constituted by a curved line. In the plastic deforming portion 12, a cross-sectional area in a cross-section orthogonal to the facing direction of the starting end surface 10a and the termination end surface 10b may be gradually reduced from the starting end portion 12a toward the termination end portion 12b, or may be gradually reduced after being gradually increased at once. From the viewpoint of effectively suppressing occurrence of cracks in the permanent magnet 2 that is obtained, it is preferable that the cross-sectional area is gradually reduced.

Note that, in the plastic deforming portion 12, when a ratio (reduction ratio of area) of an area of the termination end portion 12b to an area of the starting end portion 12a is set to 60% to 90% (as an example, 85%), a hot deformed magnet having high magnetic characteristics (for example, residual magnetic flux density) can be obtained.

In addition, in the plastic deforming portion 12, the end surface of the starting end portion 12a and the end surface of the termination end portion 12b may have a parallel positional relationship (for example, all of the end surfaces extend in the X-direction) instead of the twisted positional relationship. In the plastic deforming portion 12, in a case where the end surface of the starting end portion 12a and the end surface of the termination end portion 12b have the twisted positional relationship, when a green compact passes through the plastic deforming portion 12, it is possible to cause relatively large plastic deformation to occur, and a hot deformed magnet having high magnetic characteristics (for example, residual magnetic flux density) can be obtained.

The outlet portion 14 includes a starting end portion 14a connected to the termination end portion 12b, and the termination end portion 14b in the termination end surface 10b. In the outlet portion 14, an area of an end surface in the termination end portion 14b is approximately the same as an area of an end surface in the starting end portion 14a.

The starting end portion 14a and the termination end portion 14b of the outlet portion 14 has an end surface shape extending in one direction when viewed from the facing direction of the starting end surface 10a and the termination end surface 10b. The end surface shape of the starting end portion 14a and the termination end portion 14b is a rectangular shape. An area of an end surface in the termination end portion 14b is approximately the same as an area of an end surface in the starting end portion 14a. In the outlet portion 14, a cross-sectional area in a cross-section orthogonal to the facing direction of the starting end surface 10a and the termination end surface 10b may be approximately constant from the starting end portion 14a toward the termination end portion 14b.

A difference (T₁−T₂) between a temperature T₁ of the green compact in the starting end portion 14a of the outlet portion 14 and a temperature T₂ of the green compact in the termination end portion 14b is 30° C. or higher. According to this, in the hot deformed magnet that is obtained, an orientation of the two-grain boundary 8 becomes non-oriented. With regard to the reason why the orientation of the two-grain boundary 8 of the obtained hot deformed magnet becomes non-oriented, the present inventors consider as follows. Specifically, when the difference (T₁−T₂) between the temperature T₁ of the green compact in the starting end portion 14a of the outlet portion 14 and the temperature T₂ of the green compact in the termination end portion 14b is 30° C. or higher, shrinkage occurs in the green compact. When the green compact shrinks, a stress that is received by the green compact is further reduced in comparison to an inner wall of the extrusion mold 10. According to this, the orientation of the two-grain boundary 8 is disturbed.

From the viewpoint that the obtained hot deformed magnet is excellent in the coercivity and the residual magnetic flux density, it is preferable that the difference (T₁−T₂) between the temperature T₁ of the green compact in the starting end portion 14a of the outlet portion 14 and the temperature T₂ of the green compact in the termination end portion 14b is 30° C. or higher, and more preferably 50° C. or higher. T₁−T₂ may be 200° C. or lower. The temperature T₁ of the green compact in the starting end portion 14a of the outlet portion 14 and the temperature T₂ of the green compact in the termination end portion 14b of the outlet portion 14 can be calculated by simulation.

An unloading rate is preferably 0.1% or more, and more preferably 0.2% or more. The unloading rate in this specification is a value that is calculated from dimensions of the green compact which are calculated from a linear expansion coefficient on the basis of a temperature of the green compact in each portion of the mold, and dimensions of each portion of the mold. Specifically, calculation is performed as follows. That is, ΔT, α, X₂, L₁, and L₂ are defined as follows.

ΔT: Difference (T₂−T₁) between a temperature T₂ of the green compact in the termination end portion 14b and a temperature T₁ of the green compact in the starting end portion 14a.

α: Linear expansion coefficient of a desired hot deformed magnet in an axis-of-easy-magnetization direction.

X₂: Length of a mold in a direction parallel to an axis of easy magnetization of the green compact in the termination end portion 14b.

L₁: Length of the green compact in a direction parallel to the axis of easy magnetization of the green compact in the starting end portion 14a.

L₂: Length of the green compact in a direction parallel to the axis of easy magnetization of the green compact in the termination end portion 14b. Calculation is performed by the following Expression (a).

L₂=(αΔT+1)×L₁ Expression (a)

The unloading rate is calculated by the following Expression (b)

Unloading rate=−{(L₂−X₂)/X₂}×100 Expression (b)

### Second Embodiment

The method of manufacturing a hot deformed magnet according to this embodiment is a method of manufacturing a hot deformed magnet by using an extrusion mold that has a starting end surface and a termination end surface which face each other, and is provided with a plastic deforming portion including a starting end portion and a termination end portion, and an outlet portion including a starting end portion and a termination end portion. The portions are sequentially connected toward the starting end surface and the termination end surface. The method of manufacturing a hot deformed magnet according to this embodiment includes a hot deforming step of hot-extruding a green compact obtained by pressing a magnetic powder from the starting end surface of the extrusion mold to the termination end surface through the plastic deforming portion and the outlet portion. In the plastic deforming portion, an area of an end surface in a termination end portion is smaller than an area of an end surface in a starting end portion. In the outlet portion, an area of an end surface in a termination end portion is larger than an area of an end surface in a starting end portion.

The method of manufacturing the hot deformed magnet according to this embodiment has the above-described configuration, and an unloading rate exceeds 0. As a result, the two-grain boundary 8 included in the permanent magnet 2 that is obtained becomes non-oriented. The unloading rate is preferably 0.1% or more, and more preferably 0.2% or more.

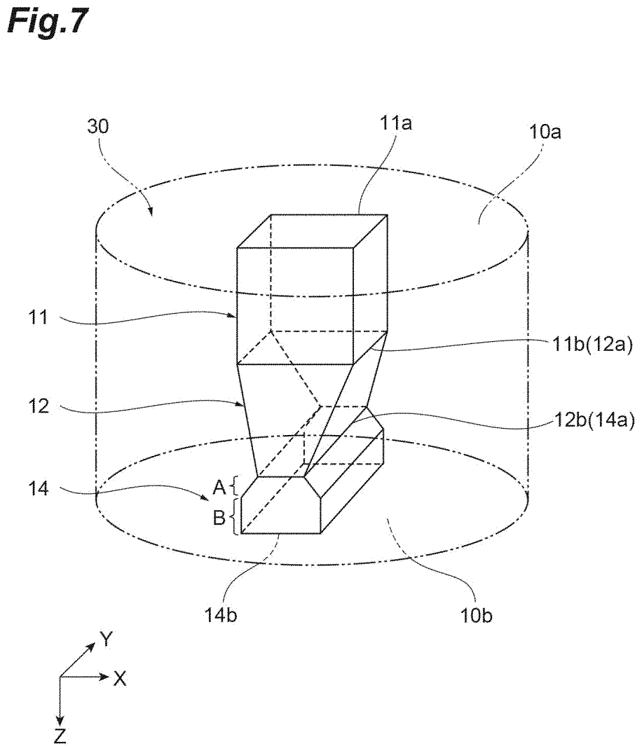

Step S1 and step S2 in the method of manufacturing the hot deformed magnet according to the second embodiment may be similar as in the method of manufacturing the hot deformed magnet according to the first embodiment. In step S3 in the method of manufacturing the hot deformed magnet according to the second embodiment, an atmosphere, a pressure, and time when performing hot deforming may be similar as in the first embodiment. In the hot deforming in this embodiment, an extrusion mold 30 illustrated in FIG. 7 is used.

The extrusion mold 30 is similar to the extrusion mold 10 except that the shape of the outlet portion 14 is different. In the extrusion mold 30, an area of an end surface in a termination end portion 14b of the outlet portion 14 is larger than an area of an end surface in a starting end portion 14a. According to this, in a hot deformed magnet that is obtained, the orientation of the two-grain boundary 8 becomes non-oriented. With regard to the reason why the orientation of the two-grain boundary 8 of the obtained hot deformed magnet becomes non-oriented, the present inventors consider as follows. Specifically, when the area of the end surface in the termination end portion 14b is larger than the area of the end surface in the starting end portion 14a, a stress received by the green compact is further reduced in comparison to an inner wall of the extrusion mold 30. According to this, the orientation of the two-grain boundary 8 is disturbed.

In the extrusion mold 30, the starting end portion 14a and the termination end portion 14b of the outlet portion 14 have an end surface shape extending in one direction when viewed from the facing direction of the starting end surface 10a and the termination end surface 10b. When being compared with the starting end portion 14a, a short side of the termination end portion 14b is longer, and a length of a long side is the same. When being compared with the starting end portion 14a, the long side of the termination end portion 14b may be longer and the short side may be the same. When being compared with the starting end portion 14a, the long side and the short side of the termination end portion 14b may be longer. The starting end portion 14a and the termination end portion 14b may not have a similar shape or may have a similar shape. The extrusion mold 30 includes a region A in which a cross-sectional area of the outlet portion 14 in a cross-section orthogonal to the facing direction of the starting end surface 10a and the termination end surface 10b is gradually increased from the starting end portion 14a toward the termination end portion 14b, and a region B in which the cross-sectional area is approximately constant. The extrusion mold 30 may include or may not include the region B in which the cross-sectional area is approximately constant as illustrated in FIG. 7. A contour in the region A of the outlet portion 14 may be constituted by a straight line as illustrated in FIG. 7, or may be constituted by a curved line.

In the outlet portion 14, a ratio (area increase ratio) of an area of the termination end portion 14b to an area of the starting end portion 14a is preferably 100.05% to 100.50% from the viewpoint that the obtained hot deformed magnet is excellent in the coercivity and the residual magnetic flux density.

A temperature of the green compact in the starting end portion 14a of the outlet portion 14 may be the same as a temperature of the green compact in the termination end portion 14b, or the temperature of the green compact in the starting end portion 14a of the outlet portion 14 may be lower than the temperature of the green compact in the termination end portion 14b. In a case where the temperature of the green compact in the starting end portion 14a of the outlet portion 14 is lower than the temperature of the green compact in the termination end portion 14b, a difference (T₁−T₂) between a temperature T₁ of the green compact in the starting end portion 14a of the outlet portion 14 and a temperature T₂ of the green compact in the termination end portion 14b may be 10° C. or higher. From the viewpoint that the obtained hot deformed magnet is excellent in the coercivity and the residual magnetic flux density, the difference is preferably 30° C. or higher, and more preferably 50° C. or higher. T₁−T₂ may be 200° C. or lower.

Hereinbefore, the method of manufacturing the hot deformed magnet according to the first and second embodiments has been described, but the invention is not limited to the above-described embodiments, and various modifications can be made within a range not departing from the gist.

In addition, the end surface shape of the starting end portion and the termination end portion of each of the inlet portion, the plastic deforming portion, and the outlet portion is not limited to the rectangular shape, and may be an elliptical shape extended in one direction, a circular shape, a U shape, or a V shape.

### EXAMPLES

Hereinafter, the invention will be described in more detail with reference to examples, but the invention is not limited by the following examples at all.

### Examples 1 to 3, and 6, and Comparative Examples 1 to 3, and 5

<Preparation of Thin Piece of Alloy>

As starting raw materials of the permanent magnet, Nd, Pr, Dy, Fe, FeB, Co, Ga, and Al were prepared. The starting raw materials were weighed and mixed so that a composition of the permanent magnet becomes a composition shown in Table 1, and the resultant mixed raw material was adjusted. A thin piece of a raw material alloy was obtained from the mixed raw material by a rapid solidification method. Specifically, first, the mixed raw material was stored in a chamber. A temperature of the stored mixed raw material was raised until reaching 1300° C., thereby obtaining a molten metal of the mixed raw material. A temperature rising rate was set to 100° C./second. The molten metal was sprayed from a nozzle to a roll according to the rapid solidification method, thereby obtaining a thin piece of an alloy. A hole diameter of the nozzle was set to 0.6 mm, a pressure at a hole portion of the nozzle was set to 240 kPa, a pressure inside the chamber was set to 200 kPa, a peripheral speed of the roll was set to 40 m/second, and an atmosphere was set to an argon gas atmosphere.

<Step S1>

The obtained thin piece of the raw material alloy was pulverized by a cutter mill to obtain a magnet powder. Pulverization was performed in an argon gas atmosphere. A concentration of oxygen in the pulverization was 20 ppm. Next, with respect to the obtained magnetic powder, particles other than a particle having a particle size of 50 to 200 μm were removed by a classifier. That is, a particle size of the magnetic powder was adjusted to 50 to 200 μm. An atmosphere in the classification was an argon gas atmosphere, and a concentration of oxygen was 20 ppm.

<Step S2>

The obtained magnetic powder was pressed by a compression molding machine, thereby obtaining a rectangular parallelepiped green compact (22 mm×11 mm×80 mm) In the pressing, a pressure was set to 100 MPa, a temperature was set to 750° C., an atmosphere was set to an argon gas atmosphere, a concentration of oxygen was set to 20 ppm, and a compression time was set to 300 minutes.

<Step S3>

The obtained green compact was put into an extrusion mold by a punch, thereby obtaining a permanent magnet. As the extrusion mold, an extrusion mold having a shape illustrated in FIG. 6 was used. An end surface shape of the starting end portion and the termination end portion of the inlet portion (inlet portion of the plastic deforming portion) was a rectangular shape extending in the X-axis direction. A length of a long side was 30.000 mm, and a length of a short length was 7.000 mm. An end surface shape of the starting end portion of the plastic deforming portion (starting end portion of the outlet portion) and the termination end portion of the outlet portion was a rectangular shape extending in the Y-axis direction. A length of a long side was 30.000 mm, and a length of a short side was 7.000 mm A temperature of the green compact in the starting end portion of the inlet portion and the starting end portion of the outlet portion was set to 750° C., and a temperature of the green compact in the termination end portion of the outlet portion was set to a value shown in Table 1. An extrusion rate was set to 1 mm/second. A pressure in the termination end portion of the outlet portion reached a value shown in Table 1. An unloading rate became a value shown in Table 1. The unloading rate is a value calculated from dimensions of the green compact which are calculated from a linear expansion coefficient on the basis of a temperature of the green compact in each portion of the mold, and dimensions of each portion of the mold. Specifically, calculation was performed as follows. That is, ΔT, α, X₂, L₁, and L₂ were defined as follows.

ΔT: Difference (T₂−T₁) between a temperature T₂ of the green compact in the termination end portion of the outlet portion and a temperature T₁ (750° C.) of the green compact in the starting end portion of the inlet portion and the starting end portion of the outlet portion

α: Linear expansion coefficient of the permanent magnet in an axis-of-easy-magnetization direction (6.5×10⁻⁶/° C.).

X₂: 7.000 mm

L₁: 7.000 mm

L₂: Length of the green compact in a direction parallel to an axis of easy magnetization of the green compact in the termination end portion of the outlet portion. Calculation is performed by the following Expression (a).

L₂=(αΔT+1)×L₁ Expression (a)

The unloading rate is calculated by the following Expression (b)

Unloading rate=−{(L₂−X₂)/X₂}×100 Expression (b)

### Examples 4, 5, and 7, and Comparative Example 4

In step S3, permanent magnets were obtained in a similar manner as in Example 1 except that an extrusion mold having a shape illustrated in FIG. 7 was used instead of the extrusion mold having a shape illustrated in FIG. 6. The extrusion mold used in the examples is similar to the extrusion mold used in Example 1 except that a shape of the outlet portion is different. In the extrusion mold used in the examples, an end surface shape of the termination end portion of the outlet portion is a rectangular shape extending in the Y-axis direction. Lengths of a long side and a short side are values shown in Table 1.

### Examples 1 to 7, and Comparative Examples 1 to 5

<Measurement of Magnetic Characteristics>

Magnetic characteristics of the obtained permanent magnets were measured by using a B-H tracer. As the magnetic characteristics, magnetic flux density (Br) at 23° C., coercivity (HcJ) at 23° C. and 150° C., and a squareness ratio (Hk/HcJ) at 23° C. were measured. Measured results are shown in Table 2.

<Calculation of Coercivity Temperature Coefficient>

A coercivity temperature coefficient (β) was calculated from the measured coercivity by the following Expression (1). Results are shown in Table 2.

(Coercivity at 150° C.−coercivity at 23° C.)/{(150−23)×Coercivity at 23° C.}×100 Expression (1)

<Measurement of Thickness of Two-Grain Boundary>

A thin film sample for measurement was prepared from the permanent magnet by using a focused ion beam (FIB). An HAADF-STEM image of the thin film sample was captured by using a STEM. As the STEM, Titan-G2 (product name) manufactured by Thermo Fisher Scientific was used. With respect to the two-grain boundary in the HAADF-STEM image, thickness was measured at 10 sites. An average value of the measured thickness was calculated, and was set as the thickness of the two-grain boundary. Results are shown in Table 2.

<Observation of Crystallinity of Two-Grain Boundary>

Presence or Absence of crystallinity of the two-grain boundary was confirmed. Specifically, in the HAADF-STEM image obtained through measurement of the thickness of the two-grain boundary, arbitrary five or more regions (2×2 nm) which are parts of the two-grain boundary were subject to FFT (two-dimensional Fourier transform) to obtain an image around a bright spot (direct spot). In at least one image among images obtained from the five or more regions, in a case where a bright spot other than the central bright spot (direct spot) was observed, it was determined that the two-grain boundary is crystalline. Results are shown in Table 2.

<Measurement of Orientation of Two-Grain Boundary>

With respect to each of the obtained permanent magnets, an orientation of the two-grain boundary was measured. Specifically, in the HAADF-STEM image obtained through measurement of the thickness of the two-grain boundary, arbitrary five or more regions (2×2 nm) constituting the two-grain boundary were subject to FFT (two-dimensional Fourier transform) to obtain an image around a bright spot (direct spot). A plurality of obtained images were compared with each other, and in a case where bright spots other than a central bright spot (direct spot) do not overlap each other, it was determined that the two-grain boundary is non-oriented. Results are shown in Table 2.

TABLE 1

| | | | | | | | | | Mold [mm] | | | | |
|---|---|---|---|---|---|---|---|---|---|---|---|---|---|
| | | | | | | | | | Termination end | | | | |
| | | | | | | | | | portion of outlet | | Temperature | | |
| | Composition of raw material | | | | | | | | portion | | of green | | Unloading |
| | Content of each element [% by mass] | | | | | | | | Short | Long | compact | Pressure | rate |
| | Nd | Pr | Dy | Fe | Co | Ga | Al | B | side | side | [° C.] | [MPa] | [%] |
| Comparative | 30.17 | 0.00 | 0.00 | Balance | 3.96 | 0.59 | 0.04 | 0.97 | 7.000 | 30.000 | 750 | 65.00 | 0.00 |
| Example 1 | | | | | | | | | | | | | |
| Example 1 | 30.17 | 0.00 | 0.00 | Balance | 3.96 | 0.59 | 0.04 | 0.97 | 7.000 | 30.000 | 700 | 64.93 | 0.11 |
| Example 2 | 30.17 | 0.00 | 0.00 | Balance | 3.96 | 0.59 | 0.04 | 0.97 | 7.000 | 30.000 | 650 | 64.85 | 0.22 |
| Example 3 | 30.17 | 0.00 | 0.00 | Balance | 3.96 | 0.59 | 0.04 | 0.97 | 7.000 | 30.000 | 600 | 64.78 | 0.34 |
| Example 4 | 30.17 | 0.00 | 0.00 | Balance | 3.96 | 0.59 | 0.04 | 0.97 | 7.005 | 30.000 | 750 | 64.784 | 0.33 |
| Example 5 | 30.17 | 0.00 | 0.00 | Balance | 3.96 | 0.59 | 0.04 | 0.97 | 7.010 | 30.000 | 750 | 64.567 | 0.67 |
| Comparative | 33.37 | 0.00 | 0.00 | Balance | 3.24 | 0.56 | 0.04 | 0.93 | 7.000 | 30.000 | 750 | 65.00 | 0.00 |
| Example 2 | | | | | | | | | | | | | |
| Comparative | 33.37 | 0.00 | 0.00 | Balance | 3.24 | 0.56 | 0.04 | 0.93 | 7.000 | 30.000 | 650 | 65.00 | 0.00 |
| Example 3 | | | | | | | | | | | | | |
| Comparative | 33.37 | 0.00 | 0.00 | Balance | 3.24 | 0.56 | 0.04 | 0.93 | 7.010 | 30.000 | 750 | 65.00 | 0.00 |
| Example 4 | | | | | | | | | | | | | |
| Comparative | 10.65 | 17.40 | 2.07 | Balance | 3.40 | 0.50 | 0.07 | 0.97 | 7.000 | 30.000 | 750 | 65.00 | 0.00 |
| Example 5 | | | | | | | | | | | | | |
| Example 6 | 10.65 | 17.40 | 2.07 | Balance | 3.40 | 0.50 | 0.07 | 0.97 | 7.000 | 30.000 | 650 | 64.85 | 0.22 |
| Example 7 | 10.65 | 17.40 | 2.07 | Balance | 3.40 | 0.50 | 0.07 | 0.97 | 7.010 | 30.000 | 750 | 64.567 | 0.67 |

TABLE 2

| | | | | Magnetic characteristics | | | | |
|---|---|---|---|---|---|---|---|---|
| | | | | | | Coercivity | Residual | |
| | Microstructure of two-grain boundary | | | Coercivity | Coercivity | temperature | magnetic | Squareness |
| | | | Thickness | (23° C.) | (150° C.) | coefficient | flux density | ratio |
| | Crystallinity | Orientation | [nm] | [kA/m] | [kA/m] | [%/° C.] | [mT] | [%] |
| Comparative | Present | Present | 1.442 | 1541 | 578 | −0.49 | 1264 | 89.0 |
| Example 1 | | | | | | | | |
| Example 1 | Present | Absent | 2.013 | 1722 | 618 | −0.50 | 1272 | 88.6 |
| Example 2 | Present | Absent | 2.623 | 1781 | 622 | −0.51 | 1334 | 89.6 |
| Example 3 | Present | Absent | 2.972 | 1743 | 628 | −0.50 | 1333 | 90.5 |
| Example 4 | Present | Absent | 1.989 | 1722 | 629 | −0.50 | 1301 | 86.5 |
| Example 5 | Present | Absent | 2.941 | 1805 | 627 | −0.51 | 1308 | 89.9 |
| Comparative | Present | Present | 3.583 | 1601 | 595 | −0.49 | 1130 | 88.8 |
| Example 2 | | | | | | | | |
| Comparative | Present | Absent | 3.849 | 1716 | 620 | −0.50 | 1109 | 86.5 |
| Example 3 | | | | | | | | |
| Comparative | Present | Absent | 4.024 | 1879 | 667 | −0.51 | 1164 | 85.5 |
| Example 4 | | | | | | | | |
| Comparative | Present | Present | 2.643 | 1830 | 689 | −0.49 | 1230 | 85.0 |
| Example 5 | | | | | | | | |
| Example 6 | Present | Absent | 2.726 | 2031 | 720 | −0.51 | 1302 | 90.0 |
| Example 7 | Present | Absent | 2.858 | 2089 | 775 | −0.50 | 1232 | 91.6 |

<Confirmation of Presence or Absence of R₆T₁₃Ga in Two-Grain Boundary>

With respect to the permanent magnet obtained in Example 5, presence or absence of R₆T₁₃Ga in the two-grain boundary was confirmed by analyzing a composition and lattice constants of the two-grain boundary. The composition of the two-grain boundary was analyzed on the HAADF-STEM image obtained through measurement of the thickness of the two-grain boundary by energy dispersive fluorescent X-ray spectroscopy (EDX). Results are shown in Table 3. In Table 3, a content ratio of R, a value (R/Ga) obtained by dividing a content ratio of R by a content ratio Ga, and a value (T/Ga) obtained by dividing a content ratio of T by the content of Ga were also shown in Table 3.

With regard to the lattice constants of the two-grain boundary, on the HAADF-STEM image obtained through measurement of the thickness of the two-grain boundary, arbitrary six regions (2×2 nm) constituting the two-grain boundary were subjected to two-dimensional Fourier transform to calculate periodicity (plane intervals and lattice constants). With regard to the calculated lattice constants, lattice constants in an a-axis direction and a b-axis direction were 0.8034 nm, and a lattice constant in a c-axis direction was 2.278 nm. The measured values approximately matched values in a document (refer to C. H. de Groot, et al., Phys. Rev. B 57 (1998) 11472, lattice constants in an a-axis direction and a b-axis direction: 0.8072 nm, and a lattice constant in a c-axis direction: 2.295 nm). From the composition and the lattice constants, it could be seen that R₆T₁₃Ga is contained in the two-grain boundary.

TABLE 3

| Content ratio of metal elements [atomic %] | | | | | | | | | Content ratio of R | | |
|---|---|---|---|---|---|---|---|---|---|---|---|
| Nd | Pr | Fe | Co | Al | Cu | Ga | Zr | Si | [atomic %] | R/Ga | T/Ga |
| 22.6 | 11.1 | 53.3 | 4.0 | 0.8 | 1.1 | 5.8 | 0.5 | 0.8 | 33.7 | 5.8 | 9.9 |

### INDUSTRIAL APPLICABILITY

For example, the R-T-B based permanent magnet according to an aspect of the invention is applied to motors equipped in a hybrid car or an electric vehicle.

### REFERENCE SIGNS LIST

2: permanent magnet, 2cs: cross-section of permanent magnet, 4: main phase grain, 6: grain boundary multiple junction, 8: two-grain boundary, 10, 30: extrusion mold, 10a: starting end surface, 10b: termination end surface, 11: inlet portion, 11a, 12a, 14a: starting end portion, 11b, 12b, 14b: termination end portion, 12: plastic deforming portion, 14: outlet portion.

What is claimed is:

1. An R-T-B based permanent magnet including a rare-earth element R, and transition metal elements T and B,
wherein the R-T-B based permanent magnet includes at least Nd as R,
the R-T-B based permanent magnet includes at least Fe as T,
the R-T-B based permanent magnet includes a plurality of main phase grains containing a crystal of R₂T₁₄B, and a two-grain boundary located between two main phase grains adjacent in an axis-of-easy-magnetization direction,
the thickness of the two-grain boundary is 3 nm or less, and
the two-grain boundary is crystalline, and is non-oriented.

2. The R-T-B based permanent magnet according to claim 1,
wherein the content of R is from 28% by mass to 33% by mass, and
the content of B is from 0.8% by mass to 1.1% by mass.

3. The R-T-B based permanent magnet according to claim 1
wherein the R-T-B based permanent magnet further includes Ga, and
the two-grain boundary is a phase containing R₆T₁₃Ga.

4. The R-T-B based permanent magnet according to claim 1,
wherein the R-T-B based permanent magnet is a hot deformed magnet.
